(19) United States
(12) Patent Application Publication
(10) Pub. No.: US 2008/0080348 A1
(43) Pub. Date: Apr. 3, 2008

(54) FOCUS CONTROL METHOD AND OPTICAL DISC DRIVE

(76) Inventors: Hiroshi KUBOTA, Machida-shi (JP); Mikio Yamamuro, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/837,125

(22) Filed: Aug. 10, 2007

(30) Foreign Application Priority Data
Sep. 29, 2006 (JP) 2006-268608

(51) Int. Cl. G11B 20/18; G11B 19/04; G11B 7/00

(52) U.S. Cl. 369/53.23

(57) ABSTRACT

By a controller, land and groove areas of an optical disc are tracked, two focus error signals are detected in PID portions in the respective land and groove areas, a difference of focus offset is calculated on the basis of the detection, and the two focus error signals are corrected so as to set the difference to zero.

### CROSS-REFERENCE TO RELATED APPLICATIONS

This application is based upon and claims the benefit of priority from prior Japanese Patent Application No. 2006-268608, filed Sep. 29, 2006, the entire contents of which are incorporated herein by reference.

### BACKGROUND OF THE INVENTION

1. Field of the Invention

The present invention relates to a focus control method of land and groove recording and, more particularly, to a focus control method and an optical disc drive, capable of optimally correcting focus offset.

2. Description of the Related Art

If information is recorded on a general DVD-RAM optical disc, an optimum focus offset is measured while data recorded in the areas of lands and grooves are reproduced or while data are recorded in the areas of lands and grooves as disclosed in, for example, Japanese Patent No. 3373417.

According to the above conventional technique, the optimum focus offset needs to be measured while data recorded in the areas of lands and grooves are reproduced or while data are recorded in the areas of lands and grooves. In addition, reproducing or recording data takes much time and the optimum focus offset cannot be measured in accordance with the condition of the optical disc.

### BRIEF SUMMARY OF THE INVENTION

The object of the present invention is to provide a focus control method and an optical disc drive, capable of setting the optimum focus offset without executing reproduction or recording of the data of the optical disc.

To achieve this object, an aspect of the present invention is a focus control method. The method comprises tracking each of land and groove areas on a land and groove recording optical disc, detecting two focus error signals from PID portions in the respective land and groove areas at the tracking, calculating focus offset from the two focus error signals, and correcting the two focus error signals so as to make the two focus error signals equal, with the focus offset.

Another aspect of the present invention is an optical disc drive. The drive comprises tracking unit for irradiating a light beam from an optical pickup head onto land and groove areas on a land and groove recording optical disc and tracing the land and groove areas, focus error detection unit for detecting focus error signals from PID portions in the respective land and groove areas tracked by the tracking unit, and controller for calculating focus offset from two of the focus error signals detected by the focus error detection unit, and for correcting the two focus error signals so as to make the two focus error signals equal, with the calculated focus offset.

The present invention can provide a focus control method and an optical disc drive, capable of setting the optimum focus offset from a PID portion in each of the areas of lands and grooves without reproducing or recording the data on the optical disc.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a notebook-type personal computer equipped with an optical disc drive according to an embodiment of the present invention;

FIG. 2 is an illustration showing an example of an outer appearance of the optical disc drive according to the embodiment of the present invention;

FIG. 3 is an illustration showing a state in which a drawer is ejected from the optical disc drive shown in FIG. 2;

FIG. 4 is a block diagram showing main components of the optical disc drive according to the embodiment of the present invention;

FIG. 5 is a flowchart of detecting focus offset to correct crosstalk of a track;

FIG. 6 is an illustration of a focus error signal in a DVD-RAM disc;

FIG. 7 is an illustration showing states of lands, grooves and PID portions on a DVD-RAM disc;

FIG. 8 is an illustration showing a signal of the PID portion in a case where a laser beam passes through a change area of the land and groove when correction is not executed; and

FIG. 9 is an illustration showing a signal of the PID portion in a case where a laser beam passes through a change area of the land and groove when correction is executed.

### DETAILED DESCRIPTION OF THE INVENTION

An embodiment of the present invention will be explained below with reference to the accompanying drawings.

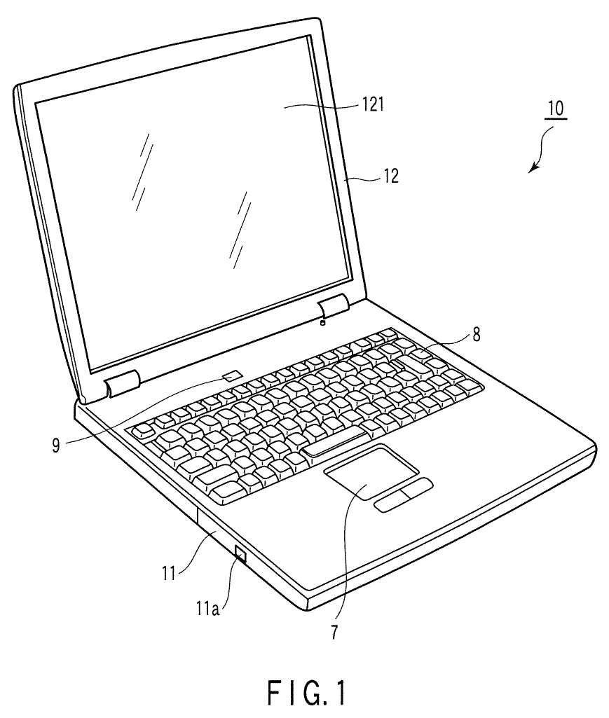

FIG. 1 shows a system configuration of an information processing apparatus. This information processing apparatus is implemented as, for example, a notebook type personal computer 10.

The present invention is the apparatus that has an optical disc such as a DVD-RAM on which data can be recorded by land and groove recording, and is capable of measuring focus offset in a short time without recording or reproducing data.

The computer 10 is composed of a main body and a display unit 12 as shown in FIG. 1. A display screen 121 of an LCD (Liquid Crystal Display) is embedded in the display unit 12.

The computer 10 comprises a power button 9, a keyboard 8, a touch pad 7, an optical disc drive 11, etc.

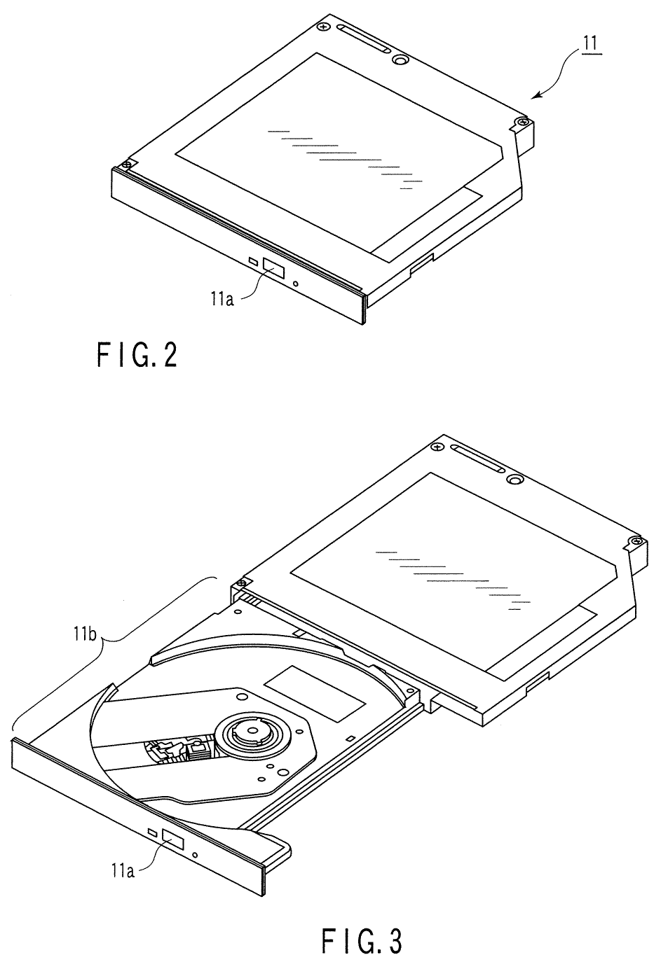

The optical disc drive 11 comprises an eject button 11a as shown in FIG. 2. By pushing down the eject button 11a, a drawer 11b is ejected as shown in FIG. 3.

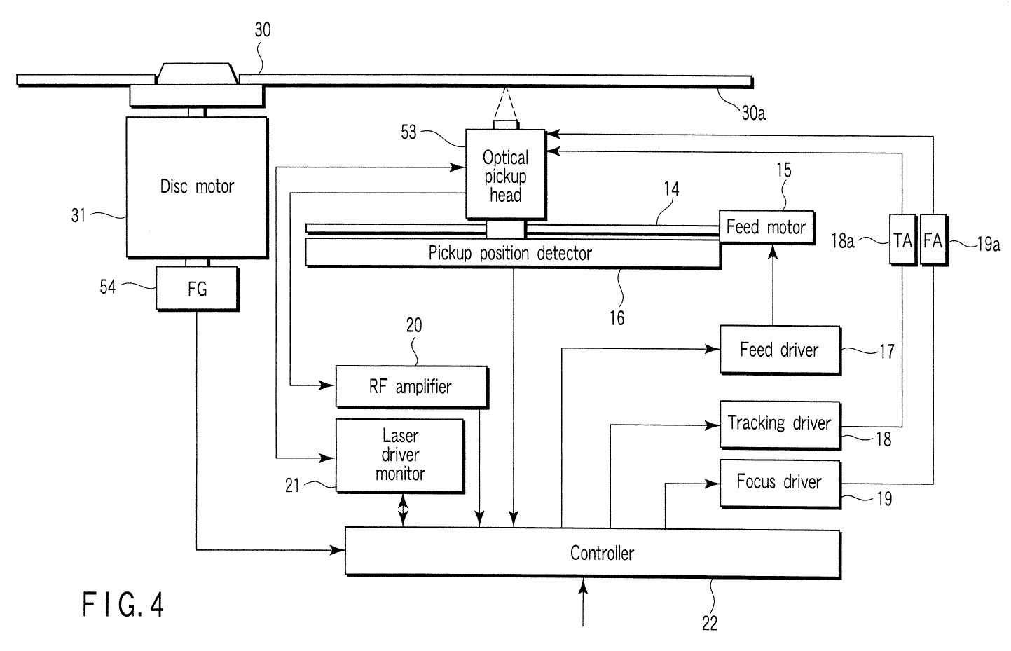

FIG. 4 is a block diagram showing a configuration of the optical disc drive 11 according to the present invention.

An optical disc 30 set in the optical disc drive 11 is an optical disc capable of recording user data or a read-only optical disc. In this embodiment, the optical disc 30 is explained as an optical disc capable of recording user data. As the optical disc, a DVD-RAM of the land and groove recording is employed. However, the optical disc is not limited to this but may be any optical disc capable of recording in the land and groove recording.

The optical disc 30 is mounted on a disc motor 31 such that a recording surface 30a faces an optical pickup head 53. The disc motor 31 is controlled to rotate on the basis of commands from a controller 22 such that a frequency of a pulse signal of an FG (motor revolution pulse output unit) 54 becomes a predetermined value. This predetermined value is varied in accordance with a radially recording position of the optical disc 30.

The optical pickup head 53 is a two-axis actuator which can move an objective in a focus direction and a track direction. The optical pickup head 53 is driven by a tracking actuator 18a and a focus actuator 19a. The tracking actuator 18a and the focus actuator 19a are driven by a tracking driver 18 and a focus driver 19, respectively, on the basis of commands from the controller 22. These actuators 18a and 19a are in, for example, moving coil type in which magnets are fixed.

In addition, the optical pickup head 53 comprises a detector (not shown) for monitoring an emitted light beam of the semiconductor laser. The detector detecting a reflected light beam from the optical disc 30 is has a multisegment structure. A detection signal output from the detector is subjected to necessary operations in an RF amplifier 20.

The optical pickup head 53 also comprises a pickup position detector 16. The pickup position detector 16 is, for example, a linear sensor, which detects radial position information on a recording surface 30a of the optical disc 30. The position information detected by the pickup position detector 16 is transmitted to the controller 22. The controller 22 compares the position information with a target position and detects a position error signal. Then, the controller 22 rotates a feed motor 15 via a feed driver 17 so as to decrease the value of the position error signal. The feed motor 15 converts the rotational motion into the linear motion by a lead screw 14 and moves the optical pickup head 53 in the radial direction. At this time, the optical pickup head 53 cannot be moved via the lead screw 14 by the feed motor 15 so as to decrease the error between the position information and the target information to zero, for the reason such as, mainly, rattle. If the feed motor 15 is constituted by a stepping motor, the error is inclined to become greater due to influences such as friction, etc. If the error is, for example, approximately 100 μm, it may be greatly varied due to influences such as the temperature, aging, etc.

To avoid the influences, the controller 22 supplies the position error signal amplified at an appropriate degree of amplification to the tracking driver 18 to drive the tracking actuator 18a. The tracking actuator 18a thereby adjusts the position of the laser spot irradiated from the optical pickup head 53 onto the optical disc 30, on the target position. Since the present embodiment does not comprise means for detecting the position of the laser spot, the occurring error depends on the above degree of amplification and the sensitivity of the tracking actuator 18a.

Data from a host controller (not shown) are transmitted to the controller 22 via a predetermined interface. On the basis of the transmitted data, a laser beam is irradiated from the optical pickup head 53 onto the recording surface 30a via a laser driver monitor 21, by the controller 22, in accordance with the angle of rotation and the radial position of the optical disc 30, such that the data, etc. are recorded and regenerated.

In consideration of the relationship among the Land, Groove, and the focus offset on a DVD-RAM disc, a greater distance than the depth of the lands and grooves needs to be corrected in accordance with the optical characteristics of the unit configured as the optical pickup head 53. The distance is what is called crosstalk.

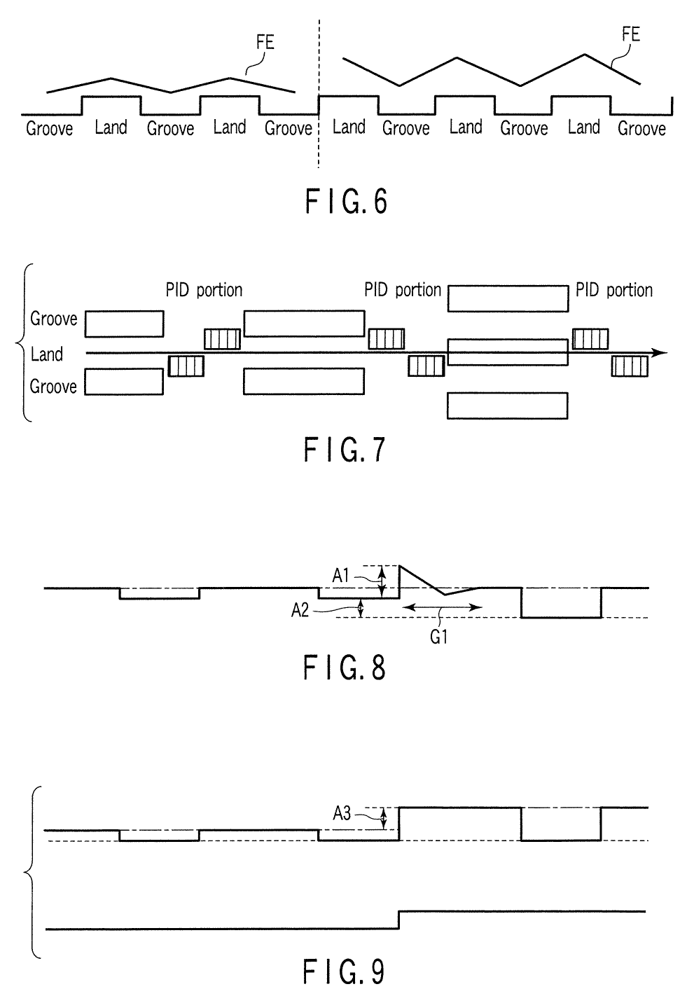

FIG. 6 illustrates, for example, focus error signal FE on the DVD-RAM disc. The left side of a dotted line shows a case where there is no track crosstalk while the right side of the dotted line shows a case where there is much track crosstalk. If such a track crosstalk occurs, the track crosstalk needs to be corrected by using the focus offset and the focus of the laser spot on which the laser beam is irradiated from the optical pickup head 53 needs to be adjusted.

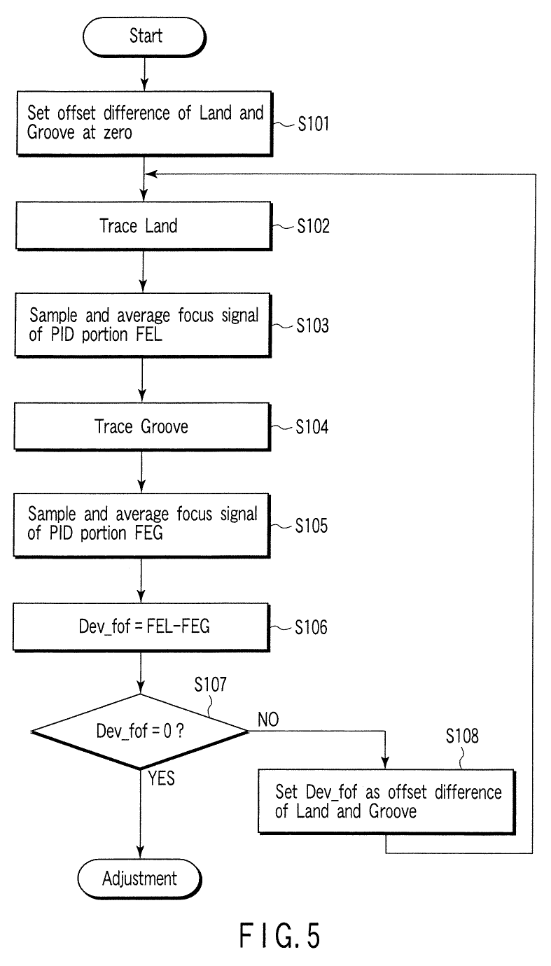

FIG. 5 is a flowchart of detecting the focus offset to correct the track crosstalk in the present invention.

Reproducing the data from the DVD-RAM disc and recording the data on the DVD-RAM disc, with the laser beam emitted from the optical pickup head 53, is described with reference to FIG. 5.

First, the controller 22 sets a difference of offset between the Land and Groove at zero (step S101). Next, the controller 22 controls the optical pickup head 53 to trace and track the Land of the DVD-RAM disc (step S102). The controller 22 samples and averages the focus signal of the PID (Physical ID) portion of the Land which is read via the RF amplifier 20 and tracked, and sets the averaged signal as focus error signal FEL (step S103).

Next, the controller 22 controls the optical disc to trace and track the Groove of the DVD-RAM disc (step S104). The controller 22 samples and averages the focus signal of the PID (Physical ID) portion of the Groove which is read via the RF amplifier 20 and tracked, and sets the averaged signal as focus error signal FEG (step S105).

The controller 22 subtracts the focus error signal FEG obtained in step S105 from the focus error signal FEL obtained in step S103, and sets the subtraction result as focus offset Dev_fof (step S106). The controller 22 discriminates whether or not focus offset Dev_fof is zero (step S107). If the controller 22 discriminates in step S107 that focus offset Dev_fof is zero, the controller 22 ends adjustment of the focus offset. On the other hand, if the controller 22 discriminates in step S107 that focus offset Dev_fof is not zero, the controller 22 shifts to step S102 and executes tracing again. Thus, if track crosstalk occurs, the controller 22 can correct focus offset Dev_fof to zero and adjust the focus of the laser spot on which the laser beam is irradiated from the optical pickup head 53.

FIG. 7 is an illustration showing a layout of the Land, Groove and PID portion of the DVD-RAM disc. FIG. 8 shows a signal of the PID portion in a case where the correction of the present invention is not executed. FIG. 9 shows a signal of the PID portion in a case where the correction of the present invention is executed.

When the laser beam passes through a change area of the Land and Groove as shown in FIG. 7, in a case of not executing correction of the above focus offset for the Land, a signal corresponding to a displacement width Al of the focus error signal generated by crosstalk and a difference A2 of the focus error signal of the PID portion generated by moving a lens of the optical pickup head 53 is generated as shown in FIG. 8. For this reason, the position is moved to the lens for the optical disc 30 and the focus cannot be adjusted to the focal point. Signal period G1 in FIG. 8 represents a period in which the lens is moved to follow a servo point.

On the other hand, the lens is not moved as shown in FIG. 9, by adjusting the focus offset such that the difference between the focus error signals detected at the Land and Groove becomes 0. Thus, the focus error signal of the PID portion also becomes immovable signal A3 and the focus can be adjusted to the correct focal point.

According to the present embodiment as described above, the Land and the Groove are tracked without reproducing or recording the data of the optical disc, and the optimum focus offset can be set in accordance with the detected focus error signals, etc.

The present invention is not limited to the embodiment described above but the constituent elements of the invention can be modified in various manners without departing from the spirit and scope of the invention. Various aspects of the invention can also be extracted from any appropriate combination of a plurality of constituent elements disclosed in the embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A focus control method, comprising:
tracking each of land and groove areas on a land and groove recording optical disc;
detecting two focus error signals from PID portions in the respective land and groove areas at the tracking;
calculating a focus offset from the two focus error signals; and
correcting the two focus error signals so as to make the two focus error signals equal, with the focus offset.

2. The method according to claim 1, wherein the focus error signals are obtained by sampling and averaging focus signals of the PID portions in the respective land and groove areas.

3. An optical disc drive, comprising:
tracking unit for irradiating a light beam from an optical pickup head onto land and groove areas on a land and groove recording optical disc and tracing the land and groove areas;
focus error detection unit for detecting focus error signals from PID portions in the respective land and groove areas tracked by the tracking unit; and
controller for calculating a focus offset from two of the focus error signals detected by the focus error detection unit, and for correcting the two focus error signals so as to make the two focus error signals equal, with the calculated focus offset.

4. The drive according to claim 3, wherein the focus error detection unit samples and averages the focus signals of the PID portions in the respective land and groove areas.
